(19) United States
(12) Patent Application Publication
(10) Pub. No.: US 2022/0207547 A1
(43) Pub. Date: Jun. 30, 2022

(54) VEHICLE PRICE ESTIMATING METHOD

(71) Applicant: JastecM CO., LTD., Gyeonggi-do (KR)

(72) Inventor: Yongbeom BAEK, Gyeonggi-do (KR)

(21) Appl. No.: 17/331,849

(22) Filed: May 27, 2021

(30) Foreign Application Priority Data
Dec. 31, 2020 (KR) 10-2020-0188585

(51) Int. Cl. G06Q 30/02; G06Q 20/36; G06K 9/62

(52) U.S. Cl. CPC G06Q 30/0206; G06Q 30/0201; G06Q 2220/00; G06K 9/6223; G06Q 20/363

(57) ABSTRACT

A method for analyzing residual value of vehicle according to an embodiment of the present disclosure includes allowing each distribution device constituting block chain to statistically process at least one of first to third data in order to analyze the residual value of the vehicle. The first data may include public data, the second data may include information on vehicle owner or driver, and the third data may include vehicle operation information.

### CROSS REFERENCE TO RELATED APPLICATION

The present application claims priority to Korean Patent Application No. 10-2020-0188585, filed on Dec. 31, 2020, the entire contents of which is incorporated herein for all purposes by this reference.

### BACKGROUND

### 1. Field of Invention

The present invention relates to method for analysis of residual value of vehicle based on a block chain.

### 2. Background to Invention

There is a need to improve the opaque transaction environment of vehicle market. In contrast to the continuous growth of the vehicle market, there is continuous consumer distrust about quality, price etc.

There is also issue relating to information securities required for vehicle transactions.

Therefore, there is need to improve market of vehicle transaction using IoT technologies such as big data, AI, blockchain etc.

### SUMMARY

According to the present invention method for analysis of residual value of vehicle comprising using IoT technology of automobiles as technology designed to collect data, big data and artificial intelligence as technology designed to analyze data, and establishing mutual authentication system distributed through a block chain to prevent forgery or alteration of information can be provided.

According to method configured to analyze residual value of vehicle, the method comprises step of allowing each distribution device constituting block chain to statistically process at least one of first to third data in order to analyze the residual value of the vehicle, wherein the first data includes public data, wherein the second data includes information on vehicle owner or driver, and wherein the third data includes vehicle operation information.

According to the present invention, a new model of process designed for calculation of vehicle price to calculate a reasonable residual value of based on a block chain can be presented.

### BRIEF DESCRIPTION OF THE DRAWINGS

FIG. 1 is a block diagram showing information mutually authenticated based on a block chain according to an embodiment of the present invention.

FIG. 2 is an explanatory diagram showing K-means clustering, linear regression analysis, and template windows according to an embodiment of the present invention.

FIG. 3 is an explanatory diagram illustrating analysis of residual value when driving distance and oil information are variables according to an embodiment of the present invention.

FIGS. 4 and 5 are graphs relating to vehicle operation information obtained from area in which a geomagnetic sensor is installed according to an embodiment of the present invention.

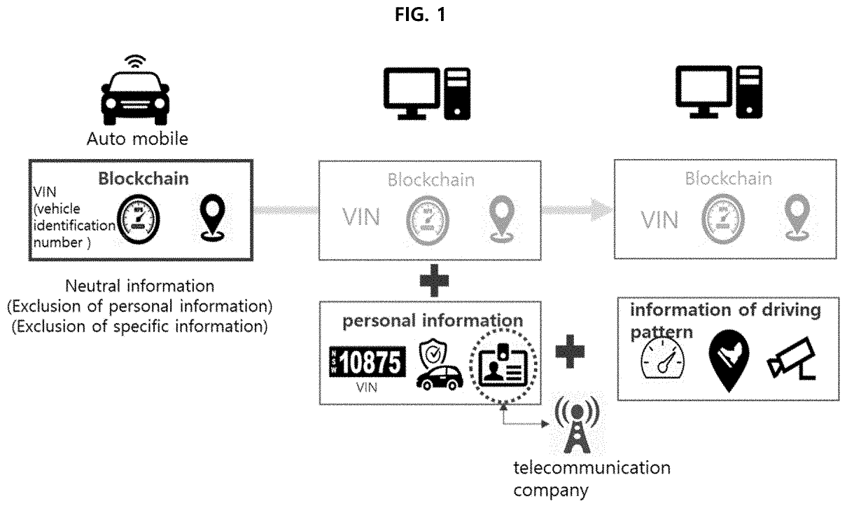

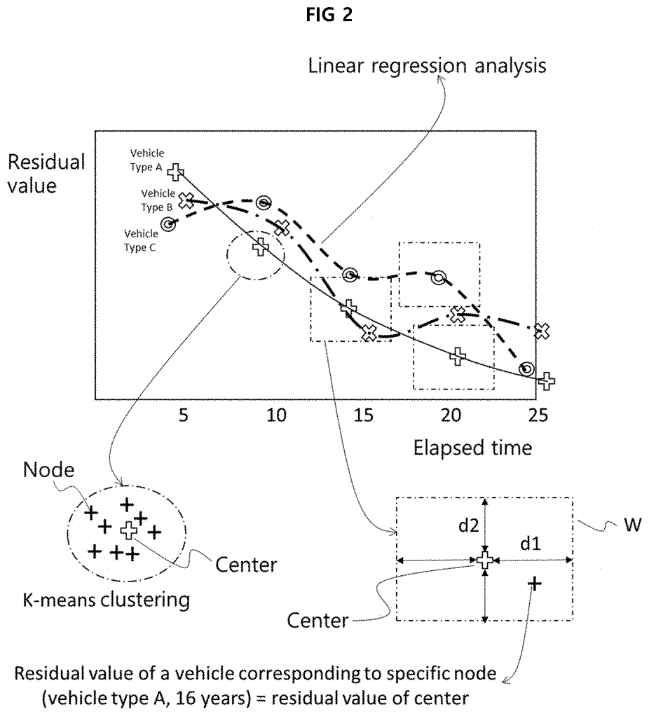

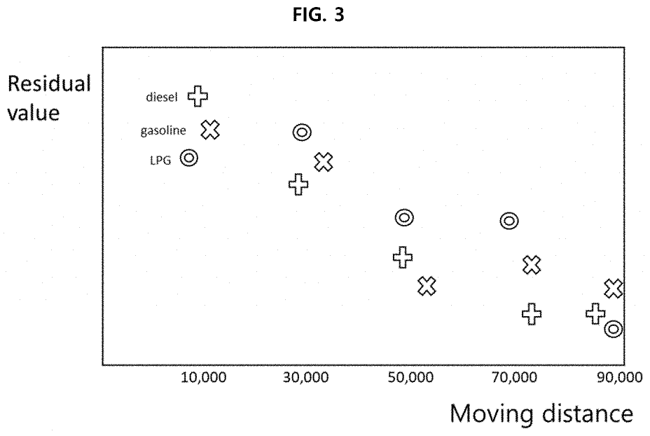

### DETAILED DESCRIPTION

Data according to the present invention are characterized as non-identifying data. In order to protect the personal information of sellers and buyers, non-identifying data or pseudonym data can be secured, which allows vehicle residual value analysis to be performed based on a blockchain.

Data can be mutually authenticated by the blockchain wallet distributed to each distribution device. The mutually authenticated data may include public data as a first data, vehicle-related data as a second data, and vehicle operation information as a third data, and these data may be input and output in a non-identifying manner. The non-identifying information may be defined as at least one of a first to a third data, in which personal information is deleted or encrypted.

The first data may be input and output via the blockchain wallet of a first distribution device. The second data can be input and output via the blockchain wallet of a second distribution device. The third data can be input and output via the blockchain wallet of a third distribution device.

The third data may be input/output to another distribution device via a blockchain wallet of the third distribution device including a vehicle or a vehicle terminal device installed in the vehicle. The third distribution device can construct a mutual authentication system for the first to third data together with other distribution devices.

Specific vehicle terminal device may input and output third data to a specific vehicle in a one-to-one manner. If a specific vehicle terminal device is removed from a specific vehicle, the one-to-one state can be failed. If the vehicle terminal device is removed from the vehicle, the mutual authentication of the first to third data may be failed or the validity of the blockchain wallet may be lost.

Accordingly, security of vehicle residual value analysis system can be enhanced. Compared to system configured to obtain security using non-identifying information only, the mutual authentication system using the blockchain wallet of the distribution device according to the present invention can significantly enhance information security.

Public data, which can be the first data, are available from a public API and include at least one of traffic accident information, automobile registration information, automobile inspection history information, automobile maintenance history information, eTAS information of commercial vehicles, and TAAS traffic accident information, which are provided in a non-identifying fashion.

The second data are information about the vehicle owner or driver, and include at least one of auto insurance information of auto insurance company, car history information of car sharing or rental agreements, car financial information of car installment or lease agreement, car sales history, vehicle model, vehicle model year, past driving records of vehicle owner.

Vehicle operation information, which can be the third data, can be information generated during vehicle operation, and be remotely input and output to a distribution device via a vehicle equipped with a blockchain wallet or a vehicle terminal device, which can be IOT device installed in a vehicle. The third data may include at least one of current location of vehicle, moving distance of vehicle, oil information, fuel consumption information, vehicle identification information, number of sudden braking and acceleration, failure information, information relating to dangerous driving, and vehicle sensor information.

The first to third data may be input and output in the form of non-identifying information via a blockchain wallet.

According to the present invention, a device configured for collection, analysis, and processing of a big data can be provided in the form of a distribution device. The third data of the vehicle terminal device may be linked to a distribution device of a private business corporations that inputs and outputs the first data and the second data via a block chain.

A blockchain-based distribution device can be implemented to obtain permission of access to necessary DB of private companies (such as insurance, financial companies, etc.) and consensus on data collection range.

In order to collect information of vehicle operation, which can be third data, using IoT technologies, procedure designed for consent of provision of information with respect to owner having personal information can be embedded in the OBD terminal device. In order to secure the integrity and reliability of the collected and non-identifying data, at least one of K-means clustering unit, linear regression analysis unit, and template window unit described below may be installed in each distribution device to construct a blockchain system.

The vehicle terminal device, which can be the third distribution device, may select item relating to driving behavior in order to collect the third data. Correlation between vehicle operation information, which is the third data, and the second data or the first data may be used for value evaluation.

In order for evaluation of residual value to reflect items relating to dangerous driving behavior such as sudden braking or sudden start, a statistical approach to the correlation between loss ratio of traffic accident and items relating to driving behavior can be installed in distribution device. For example, means configured to calculate weighted value using an Analytic Hierarchy Process (AHP) may be provided. The distribution device can implement a consistency test and weighting of similar data, which can be collected from multiple routes, in the form of blockchain wallet.

The distribution device can obtain the user's age, the user's gender, vehicle type, vehicle registration area, insurance discount, insurance premium, insurance subscription history, traffic law violation history, etc., and reflect them in residual value evaluation unit.

The distribution device may calculate residual value of vehicle based on information of vehicle driving and information of driving pattern.

A vehicle terminal device configured to collect information of vehicle driving may be installed in vehicle. The vehicle terminal device may include, for example, an On Board Diagnostics (OBD) terminal device. The vehicle terminal device can collect at least one of vehicle location, vehicle driving distance, vehicle condition information, and driving pattern information, and the distribution device may calculate the residual value of the vehicle using the information.

The distribution device may include at least one of device configured to calculate residual value of vehicle, application service device, device configured for supply of vehicle information, and device configured for calculation of vehicle moving distance.

User terminal device is a terminal device, through which user can be provided with a series of services related to residual value of the vehicle, and may include mobile phone of user.

Application service device may provide related services provided by the residual value of vehicle. For example, the related services may be application services such as calculation of insurance premiums and lease rate according to residual value of vehicle.

Device configured to calculate residual value of vehicle may calculate the vehicle residual value using information obtained from vehicle terminal device, device configured to provide vehicle information, device configured to calculate vehicle moving distance, and the like.

Device configured to calculate vehicle moving distance may calculate the moving distance of vehicle using vehicle moving information obtained from vehicle terminal device. Device configured to provide vehicle information may provide information on vehicle such as a vehicle model, vehicle model number, and vehicle model year.

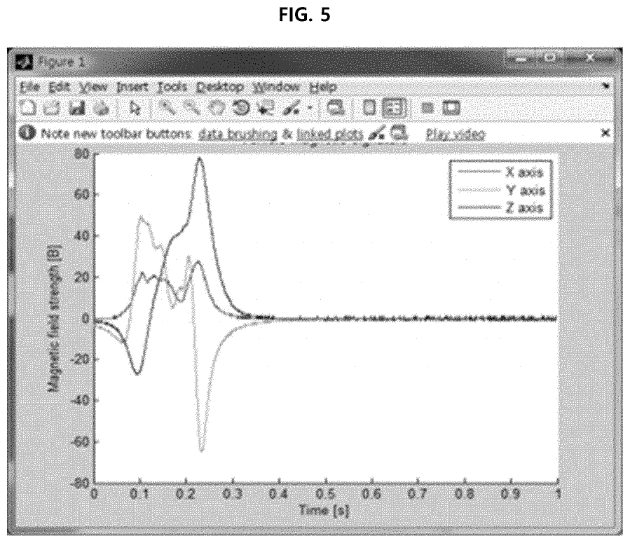

Referring to FIG. 5, K-means clustering unit, linear regression analysis unit, and template window unit will be described.

Clustering may be meant by clustering data when there are a multiple of data. Clustering similar data together can be made for ready management. For clustering, the K-means algorithm can be used.

K-means clustering unit may receive N nodes as data and receive the number K of clusters. For example, if K is equivalent to 3, a command for clustering N data into three clusters is input to the unit.

A first step is step configured to set a first node randomly selected from any of several nodes as center of a first cluster.

A second step is step configured to set a second node located at the furthest distance from the first node as center of a second cluster.

A third step is step configured to set a Kth node located at the furthest distance from the first node and the second node as a center of a Kth cluster.

A fourth step is a step configured to correspond all of N data to any one of the K clusters.

A fifth step is a step configured to change center of a specific cluster to a node located at the center of the corresponding cluster and repeat the fourth step.

A sixth step is a step configured to repeat the fifth step and terminate when the position of the center of each cluster is no longer changed.

The following describes linear regression analysis unit.

The linear regression analysis unit may be meant by modeling of a linear relationship between data. For example, elapsed time can be defined as period of time, during which a specific vehicle has been used since it is a new vehicle. By putting a first variable, the vehicle type m1 and a second variable, the elapsed time m2, into the residual value function G(m1, m2) obtained by the linear regression analysis unit, the residual value in respect of each elapsed time of the corresponding vehicle type can be obtained.

For example, if elapsed time of vehicle type A is 13.6 years, 10 million Korean Won can be obtained as the output value of the residual value function G (vehicle type A, 13.6 years). If the residual value function G(m1, m2, . . . , mp) is obtained by the linear regression analysis unit and the first variable to the p-th variable is put into the residual value function, it is advantageous that the residual value of the vehicle can be obtained as the output value of the residual value function, which is a continuous function.

If clustering of a plurality of input data is made by the K-means clustering unit, the center of each cluster is calculated by the K-means clustering unit, and centers of each cluster are connected by the linear regression analysis unit, the residual value function G(m1, m2, . . . , mp), which is a continuous function having dependent variables including the first variable to the p-th variable, can be obtained.

By putting the first variable to the p-th variable into the residual value function G(m1, m2, . . . , mp) it is advantageous that the residual value of the vehicle can be continuously obtained.

The following describes the template window unit. As the linear regression analysis unit is method designed for representation to obtain a continuous function from the discrete data, there may be analysis error. In contrast, template window unit is advantageously able to obtain the residual value of a discretely distributed specific point within a tolerance range if it is not appropriate to obtain the residual value function by the linear regression analysis unit.

If clustering of a number of input data is made by the K-means clustering unit, calculating of center of each cluster is made by the K-means clustering unit, and setting a virtual template window at a location separated from each center by a tolerance error (d1 or d2), a specific node falls within the range of the template window unit, residual value of the specific node can be regarded as the same as the residual value of center of the corresponding template window unit. The template window unit may have various shapes such as a circle or a polygon depending on how the tolerance error (d1 or d2) is set.

For example, it is assumed that residual value of the center of cluster corresponding to vehicle type A, which corresponds to elapsed time of 15 years, is 20 million Korean Won and that the tolerance error d1 is 4 years. A vehicle of vehicle type A having a specific node and elapsed time of 16 years can be regarded as belonging to a specific template window unit (W). The residual value of the vehicle can be regarded as the same value as the residual value of 20 million Korean Won at the center of the template window unit. The template window unit is advantageous in that it is possible to estimate the residual value of an arbitrary vehicle using a simple algorithm, which is based on whether the residual value falls within tolerance error based on various residual value data collected in advance.

The following describes geomagnetic sensor collecting information of vehicle operation together with a vehicle terminal device: The geomagnetic sensor is installed in road environment and can collect information of vehicle operation around the location where the geomagnetic sensor is installed and transmit the information to the distribution device.

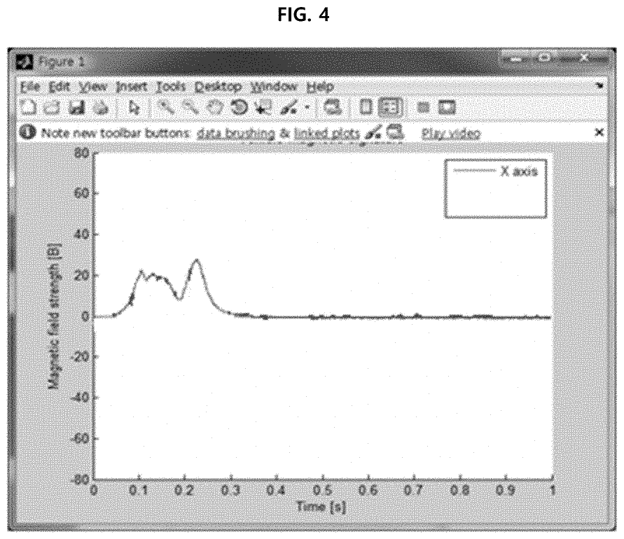

Change in earth's magnetic field, which takes place due to the movement of the vehicle, may occur about each axis at the point where the geomagnetic sensor is installed. FIG. 4 shows measurement of change in geomagnetic field about one axis (x-axis), and FIG. 5 shows measurement of change in geomagnetic field about three axes (x, y, and z-axis). According to measurement set forth in FIG. 5 it is advantageously possible to obtain information of vehicle driving by way of averaging output values of multiple axis, and that the measurement is noise robust and able to obtain information of vehicle driving in more detail.

When a value larger than the threshold value is output during uniaxial measurement and multi-axis measurement of FIG. 5, it is possible to transmit information on whether or not vehicle rather than person or bicycle passes by the sensor or on size and weight of vehicle passing by the sensor without noise.

The geomagnetic sensor compares the pre-input threshold value with the measurement value, recognizes the measurement value exceeding the threshold value as information of vehicle driving, and transmits it to the dispersion device. The transmitted information of vehicle driving may include at least one of time when vehicle passes, the number of vehicles passing during a predetermined time, estimated size and weight of vehicle, and a vehicle speed.

The distribution device can obtain the third data from vehicle terminal device installed in the vehicle as well as environmental sensors including geomagnetic sensors, and accumulate big data to perform more accurate analysis of residual value.

What is claimed is:

1. A method for analyzing residual value of vehicle, comprising allowing each distribution device constituting block chain to statistically process at least one of first to third data in order to analyze the residual value of the vehicle, wherein the first data includes public data, the second data includes information on vehicle owner or driver, and the third data includes vehicle operation information.

2. The method of claim 1, wherein the first to third data is input and output as non-identifying information, the non-identifying information being information obtained by deleting or encrypting personal information of the first to third data.

3. The method of claim 1, wherein public data being the first data are open from a public API and comprises at least one of non-identifying traffic accident information, vehicle registration information, automobile inspection history information, automobile maintenance history information, eTAS information of commercial vehicles, and TAAS traffic accident information, and input and output via blockchain wallet of the first distributed device;
the second data is information about the vehicle owner or driver, and comprises at least one of auto insurance information of an automobile insurance company, car sharing or rental car history information, car financial information related to car installment or lease, car sales history, vehicle model, vehicle model year, and the past operation records of vehicle owner, and is input and output via the blockchain wallet of the second distributed device; and
vehicle operation information being the third data is information generated during vehicle operation, and comprises at least one of current vehicle location, vehicle travel distance, oil information, fuel consumption information, vehicle identification information, number of sudden braking and acceleration, failure information, and information relating to dangerous driving, and vehicle sensor information, and input and output via the blockchain wallet of the third distributed device.

4. The method of claim 1, wherein the third data is input and output to another distribution device via block chain wallet of a third distribution device comprising a vehicle or a terminal device installed in the vehicle.

5. The method of claim 1, wherein the first data or the second data is input and output via a blockchain wallet of a first distribution device or a block chain wallet of a second distribution device;
the third data is input and output via a blockchain wallet of a third distribution device comprising a vehicle or a terminal device installed in the vehicle;
the third distribution device mutually authenticates the first to third data along with another distribution device; and
the mutual authentication of the first to third data is failed when the terminal device is removed from a specific vehicle.

6. The method of claim 1, wherein at least one of a K-means clustering unit, a linear regression analysis unit, and a template window unit for statistically processing the first to third data is provided in the form of a block chain.

7. The method of claim 1, wherein a K-means clustering unit is provided in the distribution device;
the K-means clustering unit receives N nodes as data and receives the number K of clusters;
a first step of setting a first node, which is randomly selected among several nodes, as the center of the first cluster,
a second step of setting a second node, which is located at the furthest distance from the first node, as the center of the second cluster,
a third step of setting the Kth node, which is located at the furthest distance from the first node and the second node, as the center of the Kth cluster,
a fourth step of making all of the N data correspond to any one of K clusters;
a fifth step of changing the center of a specific cluster to a node being located at the center of the corresponding cluster and repeating the fourth step; and
a sixth step of repeating the fifth step and ending when the position of the center of each cluster no longer changes.

8. The method of claim 1, wherein a K-means clustering unit and a linear regression analysis unit are provided in the distribution device;
clustering a plurality of input data via the K-means clustering unit;
calculating a center of each cluster via the K-means clustering unit;
connecting the center of each cluster via the linear regression analysis unit;
obtaining the residual value function G(m1, m2, . . . , mp), which is a continuous function having first variable to p-th variable as a dependent variable,
continuously obtaining the residual value of the vehicle by putting the first variable to the p-th variable into the residual value function G(m1, m2, . . . , mp).

9. The method of claim 6, wherein rein a K-means clustering unit and a linear regression analysis unit are provided in the distribution device;
clustering a plurality of input data via the K-means clustering unit;
calculating a center of each cluster via the K-means clustering unit;
setting the template window unit at a position distanced from each center by an allowable error;
determining that the residual value of the specific node is the same as the residual value of the center of the template window unit when a specific node falls within the range of the template window unit.

10. The method of claim 1, wherein the distribution device calculates the residual value of the vehicle according to whether residual value of an arbitrary vehicle falls within an allowable error range based on previously collected data.

11. The method of claim 1, wherein the third data are obtained from a terminal device installed in a vehicle and a geomagnetic sensor installed in a road.

12. The method of claim 1, wherein the method comprising Installing geomagnetic sensor;
the geomagnetic sensor compares the pre-input threshold value with the measured value;
recognizing the measured value exceeding the threshold value as vehicle driving information and transmitting the measured value to the distribution device;
the vehicle driving information transmitted to the dispersion device includes at least one of a vehicle passing time, the number of vehicles passing during a predetermined period of time, an estimated vehicle size and weight, and a vehicle speed.
